(19) United States
(12) Patent Application Publication
(10) Pub. No.: US 2009/0160404 A1
(43) Pub. Date: Jun. 25, 2009

(54) INFORMATION PROCESSING APPARATUS

(75) Inventor: Takashi Iwai, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/323,390

(22) Filed: Nov. 25, 2008

(30) Foreign Application Priority Data
Dec. 19, 2007 (JP) 2007-327931

(51) Int. Cl. H02J 7/02

(52) U.S. Cl. 320/138

(57) ABSTRACT

An information processing apparatus includes: a connector for connecting an electronic device; a communication path for communicating a data signal with the electronic device connected to the connector; a power supply path for supplying and receiving electric power to and from the electronic device connected to the connector; a detection unit that detects a power state of the information processing apparatus; and a switching unit that switches a direction of electric current flowing on the power supplying path according to the power state detected by the detection unit between one of a first direction in which the electric current flows to supply the electric power from the information processing apparatus to the electronic device and a second direction in which the electric current flows to receive the electric power from the electronic device.

### CROSS-REFERENCE TO RELATED APPLICATIONS

This application is based upon and claims the benefit of priority from Japanese Patent Application No. 2007-327931, filed on Dec. 19, 2007, the entire content of which are incorporated herein by reference.

### BACKGROUND

1. Field

One embodiment of the present invention relates to an information processing apparatus that is capable of recharging a battery of the apparatus by a power supplied from an electronic device that is connected to the apparatus

2. Description of the Related Art

An information processing apparatus that is assumed to be used outside, such as a notebook-type computer and a PDA (Personal Digital Assistance), has a small size and a light weight to easily carry the apparatus, as compared with a so-called desktop-type apparatus. When the apparatus has a small size, a battery mounted therein also has to be in a small size to be fit into a size of an apparatus body. From this viewpoint, it is difficult to improve capacity of the battery, and there may be a lot of cases that the remaining amount of the battery is short in use at outside.

There is proposed an information processing apparatus having a function of supplying electric power by a USB host controller to an external device, such as a digital camera, connected to o a USB port provided in the apparatus. When a sub power button is switched on, a power supply controller supplies electric power to the USB host controller and sends a notification to the USB host controller to enable power supply through an external interface. In accordance with the notification, the USB host controller enables only a function of supplying electric power and supplies the electric power to the external device connected thereto without activating other components.

According to this configuration, electric power is supplied from the information processing apparatus to the external device (an external peripheral device) without consuming extra electric power for activating other components as such by starting up to run the operating system and waiting for the operating system to be booted.

An example of such conventional configuration is disclosed in JP-A-2001-242965.

In the configuration disclosed in JP-A-2001-242965, it is possible to supply electric power from the information processing apparatus to the external device, such as the digital camera. However, there is no description about how to supply electric power from the external device, such as the digital camera, to the information processing apparatus. When the remaining battery of the information processing apparatus is short, the information processing apparatus could not be recharged in a situation where a user does not carry an AC adaptor to perform recharge. The user cannot recharge the information processing apparatus without the AC adaptor.

### SUMMARY

According to a first aspect of the present invention, there is provided an information processing apparatus including: a connector for connecting an electronic device; a communication path for communicating a data signal with the electronic device connected to the connector; a power supply path for supplying and receiving electric power to and from the electronic device connected to the connector; a detection unit that detects a power state of the information processing apparatus; and a switching unit that switches a direction of electric current flowing on the power supplying path according to the power state detected by the detection unit between one of a first direction in which the electric current flows to supply the electric power from the information processing apparatus to the electronic device and a second direction in which the electric current flows to receive the electric power from the electronic device.

According to a second aspect of the present invention, there is provided an information processing apparatus including: a power controller that is connectable with a power source including a rechargeable battery and supplies power from the power source; a connector for connecting an electronic device; a communication unit that communicates with the electronic device connected to the connector; a detection unit that detects a operational status of the apparatus; a charge control circuit that switches power supplying path between (1) a first path for supplying electrical power from the power source through the connector to the electronic device and (2) a second path for supplying electrical power from the electronic device through the connector to the rechargeable battery, in accordance with the operational status detected by the detection unit.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate an embodiment of the invention and not to limit the scope of the invention.

FIG. 1 is an external perspective view illustrating a computer according to an embodiment of the present invention.

FIG. 2 is a block diagram illustrating an internal configuration of the computer according to the embodiment.

FIG. 3 is a schematic diagram illustrating a state where the computer according to the embodiment is in use.

FIG. 4 is a schematic diagram illustrating a state where the computer according to the embodiment is in use.

FIG. 5 is a diagram illustrating a configuration of a charge control circuit according to the embodiment.

### DETAILED DESCRIPTION

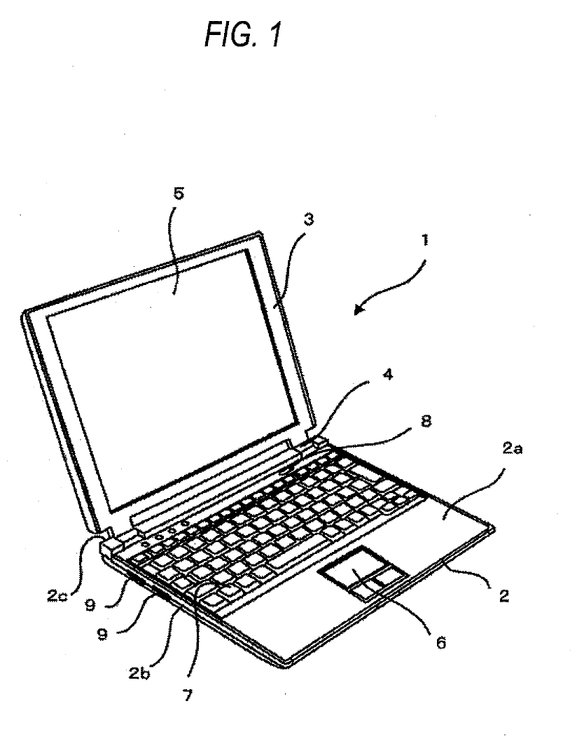

An embodiment of the present invention will be described with reference to the drawings. In the embodiment, a notebook-type computer is described as an example of an information processing apparatus according to the present invention. FIG. 1 is an external perspective view illustrating a computer 1 according to the embodiment. A display unit 3 is rotatably attached to a main unit 2 of the computer 1 through a hinge portion 4. The display unit 3 is rotatable between an opened position where an upper face 2a of the main unit 2 is exposed and a closed position where the upper face 2a of the main unit 2 is covered by the display unit 3. The display unit 3 is provided with a display device, such as an LCD (Liquid Crystal Display) panel 5.

The main unit 2 is provided with a circuit board (not shown) mounted with a plurality of electronic components. On the upper face 2a of the main unit 2, a touchpad 6 and a keyboard 7 that are operated to input an operation by a user are provided. The circuit board provided in the main unit 2 will be described later. On the upper face 2a of the main unit 2, a power button 8 for turning on or off the power of the computer 1 is provided. On a side face 2b of the main unit 2, a USE connector 9 for connecting USE devices is provided. The USE devices including digital cameras and other computers may be connected to the USE connector 9 through a USE straight cable or a USB cross cable. In the present embodiment, the USE device or another computer connected to the computer 1 is referred to as an electronic device. In the example shown in FIG. 1, two USB connectors are provided on the side face 2b of the main unit 2. However, the computer 1 may be provided with any number of USB connectors. The position where the USB connectors are provided is not limited to the side face 2b, and the USB connectors may be provided on a back face 2c of the main unit 2.

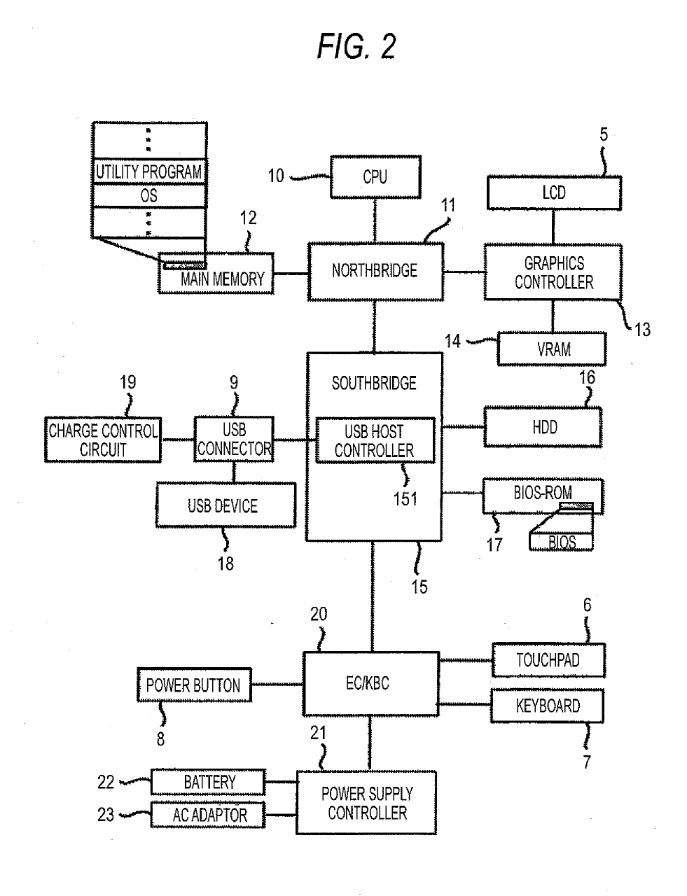

FIG. 2 is a block diagram illustrating a configuration of the computer 1 according to the embodiment. The computer 1 includes, as a main component, a CPU 10, a northbridge 11, a main memory (RAM) 12, a graphics controller 13, a VRAM 14, a southbridge 15, a USB host controller (communication unit) 151, a hard disk drive (HDD) 16, a BIOS-ROM 17, an embedded controller/keyboard controller IC (EC/KBC) 20, an LCD panel 5, a touchpad 6, a keyboard 7, a power button 8, and a USB connector 9.

The CPU 10 is a processor for controlling operations of other components provided in the computer 1. The CPU 10 runs an operating system and various kinds of application programs and utility programs loaded from the HDD 16 to the main memory (RAM) 12. The main memory (RAM) 12 is also used as a buffer and temporary storage to store various kinds of data. The CPU 10 also executes a BIOS (Basic Input Output System) stored in The BIOS-ROM 17. The BIOS is a program for hardware control. The BIOS program includes a BIOS driver group, and BIOS drivers include a plurality of function executing routine groups corresponding to functions thereof to provide a plurality of functions for hardware control to the operating system or the application program.

The northbridge 11 is a bridge device connected between a local bus of the CPU 10 and the southbridge 15. The northbridge 11 also has a function of communicating with the graphics controller 13 through a bus, such as a PCI Express bus. The northbridge 11 has a built-in memory controller for controlling the main memory (RAM) 12.

The graphics controller 13 is a display controller for controlling the LCD panel 5 used as a display device of the computer 1. The graphics controller 13 outputs a video signal in accordance with a display data recorded in the video memory (VRAM) 14 by the OS or the application program, to the LCD panel 5.

The southbridge 15 is connected to PCI (Peripheral Component Interconnect) bus and an LPC (Low Pin Count) bus. The southbridge 15 has a built-in USB host controller 151. The USB host controller 151 is controlled by a power supply controller 21 in accordance with a power state and supplies electric power supplied from a battery 22 or from an external power supply such as an AC adaptor 23 to the external device connected to the UDB connector 9 under a state where the computer 1 is not activated.

The HDD (Hard Disk Drive) 16 stores an OS, various kinds of application programs, and data files. The USB device 18 is connected through the USB connector 9 shown in FIG. 1. The USB device 18 is connected to the southbridge 15 through the USB bus, and the USB device 18 is controlled by the USB host controller 151 built in the southbridge 15.

A charge control circuit 19 performs a charge control of the USB device 18 connected through the USB connector 9 and a recharge control of the computer 1 when electric power is received from other electronic device connected to the USB connector 9.

The embedded controller/keyboard controller (EC/KBC) 20 is a one-chip microcomputer in which an embedded controller for managing electric power and a keyboard controller for controlling the touchpad 5 and the keyboard 6 are integrated. The EC/KBC 20 performs a process of turning on or off the power of the computer 1 in response to the power button 8 operated by a user, together with the power supplying controller 21 connected through an I2C bus. The power supply controller 21 supplies electric power to components provided in the computer 1, using electric power of the battery 22 built in the computer 1 or electric power supplied from the outside through the AC adaptor 23. The power supply controller 21 also supplies electric power to the connected USB device 9 through the USB host controller 151.

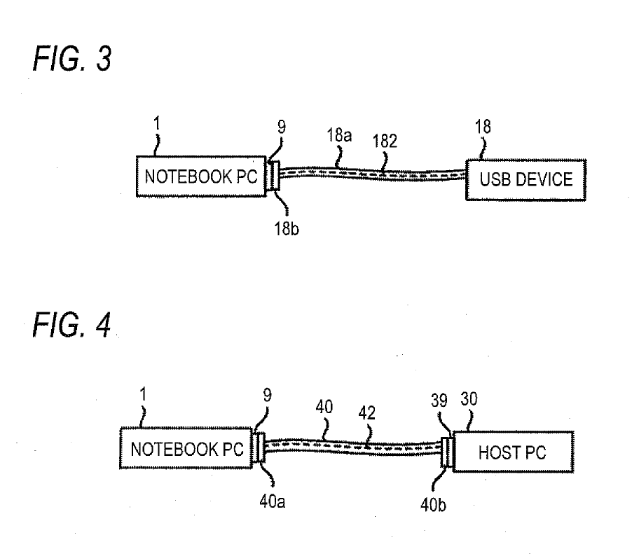

FIG. 3 and 4 are schematic diagrams illustrating a state of usage of a computer according to the embodiment. FIG. 3 shows a state where the computer 1 and the USB device 18 are connected to each other. A plug 18b attached to one end of a cable 18a extending from the USB device 18 is connected to the USB connector 9 of the computer 1. When the USB device 18 is connected during system activation of the computer 1, the computer operates in a power supply mode. The computer 1 is capable of supplying electric power to the USB device 18 through a power supplying path 182 provided in the USB cable 18a.

FIG. 4 shows a state where the computer 1 and another computer are connected to each other. Herein, to discriminate both computers, the computer 1 described in the embodiment is referred to as a notebook PC, and another computer connected to the computer 1 is referred to as a host PC 30. The computer 1 (notebook PC) and the host PC 30 are connected to each other through a USB cross cable 40. A plug 40a connected to the USB connector 9 and a plug 40b connected to a USB connector 39 of the host PC 30 are provided at both ends of the USB cross cable 40. When the host PC 30 is connected while the power of the computer 1 is turned off (or being shutdown), the computer 1 operates in a power reception mode. The computer 1 is capable of supplying electric power from the host PC 30 to the computer 1 through a power supply path 42 provided in the USB cross cable 40. In addition to the state where the computer 1 is turned off, when the computer 1 is a hibernation standby state, the computer 1 may operate in the power reception mode and may receive electric power from the host PC 30 connected through the USB cross cable 40.

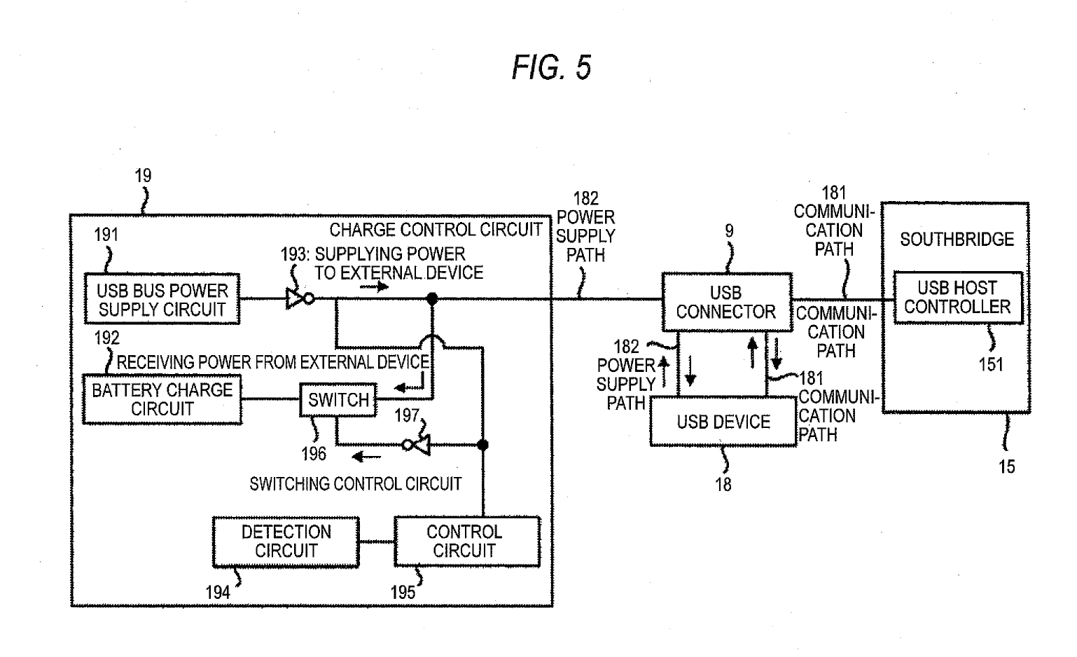

FIG. 5 is a diagram illustrating a configuration of a charge control circuit according to the embodiment. In FIG. 5, although the USB device 9 is shown to be connected to the computer 1 as an example, other external devices, such as the host PC 30, may be connected thereto as described above. The computer 1 and the USB device 18 connected to the USB connector 9 are capable of serially transmitting digital data in two ways through a communication path 181 for data communication. The computer 1 is capable of supplying electric power to the USB device or the host PC 30 connected to the computer 1 through a power supply path 182 including a power supply line and aground line.

The charge control circuit 19 shown in FIG. 2 is provided with a USB bus power supply circuit 191 and a battery charging circuit 192. The USB bus power supply circuit 191 supplies electric power to the USB device 18 or the host PC 30 connected to the computer 1 through the USB connector 9 through the power supply path 182. A diode 193 is disposed on the power supply path 182 between the USB bus power supply circuit 191 and the USB connector 9 to prevent reverse flow of electric current.

The battery charging circuit 192 receives electric power from the host PC 30 to charge the battery 22 when the computer 1 operates in the power reception mode. A detection circuit 194 detects a power state (operational status) of the computer 1 as to whether the computer 1 is under system activation or shutdown, or whether the computer 1 operates in a power-saving mode such as hibernation mode and suspension mode. In other words, the detection circuit 194 determines the operational status of the computer 1 to be in one of: a powered-on mode in which the apparatus is powered on; a powered-off mode in which the apparatus is powered off; and the power-saving mode in which the apparatus operates in minimum power.

The control circuit 195 transmits a switching control signal to the switch 196 provided between the battery charging circuit 192 and the USB connector 9, according to the power state of the computer 1 detected by the detection circuit 194. The control circuit 195 transmits the switching control signal to the switch 196, thereby switching whether supplying electric power to the battery charging circuit 192 or not.

In the embodiment, when the computer 1 is under shutdown or the power saving mode such as hibernation or suspension, electric power is supplied from the host PC 30 connected to the computer 1 through the power supply path 182 to the battery charging circuit 192. A diode 197 is disposed between the control circuit 194 and the switch 195 to prevent reverse flow of electric current.

According to the configuration as described above, when the USB device 9 is connected to the computer 1, the computer 1 communicates data with the USB device 9 and supplies electric power to the USB device 9, and when the host PC 30 is connected to the computer 1, the computer 1 receives electric power from the host PC 30 to charge the computer 1.

When the portable electronic device such as the notebook-type computer according to the embodiment can be recharged through the USB cable, it is not necessary to carry the AC adaptor dedicated for the portable electronic device, such as the computer 1. Accordingly, the portable electronic device can be charged by another electronic device by using the USB cross cable. As described above, according to the present invention, there is provided an information processing apparatus that is capable of supplying and receiving electric power by connecting another electronic device.

The present invention is not limited to the above-described embodiment, and various modification may be applied within the claimed scope of present invention.

What is claimed is:

1. An information processing apparatus comprising:
a connector configured to connect to an electronic device;
a communication path for communicating a data signal with the electronic device connected to the connector;
a power supply path for supplying and receiving electric power to and from the electronic device connected to the connector;
a detection module configured to detect a power state of the information processing apparatus; and
a switch configured to switch a direction of electric current flowing on the power supplying path according to the power state detected by the detection module between a first direction in which the electric current flows to supply the electric power from the information processing apparatus to the electronic device and a second direction in which the electric current flows from the electronic device in order to receive the electric power.

2. The apparatus of claim 1, wherein the apparatus comprises a power supply mode in which the electric power is supplied to the electronic device and a power reception mode in which the electric power is received from the electronic device, and
wherein the apparatus is configured to operate in the power supply mode while a system of the apparatus is active and to operate in the power reception mode while the system is non-active.

3. The apparatus of claim 1 further comprising:
a battery; and
a battery charger configured to receive the electric power from the electronic device and to charge the battery.

4. An information processing apparatus comprising:
a power controller configured to connect to a power source comprising a rechargeable battery and to supply power from the power source;
a connector configured to connect to an electronic device;
a communication module configured to communicate with the electronic device connected to the connector;
a detection module configured to detect a operation status of the apparatus;
a charge controller configured to select a power supplying path by switching between (1) a first path for supplying electrical power from the power source through the connector to the electronic device and (2) a second path for supplying electrical power from the electronic device through the connector to the rechargeable battery, in accordance with the operation status detected by the detection module.

5. The apparatus of claim 4 further comprising the rechargeable battery.

6. The apparatus of claim 4, wherein the power controller is configured to connect to an AC adapter as the power source.

7. The apparatus of claim 4, wherein the charge controller comprises a switch configured to switch between the first path and the second path.

8. The apparatus of claim 4, wherein the detection module is configured to determine that the operation status is either in a powered-on mode in which the apparatus is powered on, in a powered-off mode in which the apparatus is powered off, or in a power-saving mode in which the apparatus operates in minimum power.

9. The apparatus of claim 8, wherein the charge controller is configured to select the first path as the power supplying path when the detection module determines that the operation status is in the powered-on mode, and to select the second path as the power supplying path when the detection module determines that the operation status is either in the powered-off mode or in the power-saving mode.

10. The apparatus of claim 4, wherein the charge controller comprises a battery charger connected to the second path and is configured to receive the electric power from the electronic device in order to charge the battery.
